(19) United States
(12) Patent Application Publication
(10) Pub. No.: US 2019/0034593 A1
(43) Pub. Date: Jan. 31, 2019

(54) VARIATION IN COST BY PHYSICIAN

(71) Applicant: International Business Machines Corporation, Armonk, NY (US)

(72) Inventor: Peter M. Bouman, Skokie, IL (US)

(21) Appl. No.: 15/658,960

(22) Filed: Jul. 25, 2017

(51) Int. Cl. G06F 19/00

(52) U.S. Cl. CPC G06F 19/328; G06F 19/3431; G06F 19/322

(57) ABSTRACT

A method for identifying variation in treatment costs by treating physician, for improving healthcare decisions, including decisions to support bundled payments. The method includes receiving a plurality of disparate medical episode data inputs and provides rules for filtering, merging and enhancing medical episode data inputs, and then statistically predicting how a treating physician's cost compares to other physicians' costs for the same type of medical episode at the same facility. The results may be applied by healthcare systems to realize fiscal, operational and resource efficiencies in a bundled payment system.

### BACKGROUND

The present disclosure relates to methods and systems for aggregating and filtering disparate data to identify the cost of a healthcare procedure, by treating physician, and to benchmark the physician's cost against other physicians.

Healthcare systems, healthcare delivery, and the costs of receiving and paying for healthcare are becoming increasingly complex. In some cases, hospitals and providers may be compensated for particular procedures under a bundled payment model, where the compensation is not based on the actual cost of a particular physician treating a particular patient at a specific facility, but instead based on a flat rate for the specific procedure. While bundled payments offer potential cost savings through improved care management and provider coordination, they also pose risk management challenges to providers, as the providers may not be compensated over the set bundle price. Thus, bundled payments may not take into account cost differences that may be attributed to a particular physician's treatment approach, the underlying health of a particular patient, or any effect that a patient's home community can have on the success and length of a patient's treatment.

In some cases, hospitals and other care providers are looking for ways to standardize costs across physicians, place of care, and type of care, to make the costs associated with procedures that are compensated under a bundled payments model more consistent and predictable. To do this, it can be helpful to understand how much of the service price variation can be attributed to the treating physician, and to the decisions that are within the physician's control, such as place of discharge and treatment plans. For example, the place that a patient is discharged to (e.g., an outpatient rehabilitation facility, an inpatient rehabilitation facility, etc.) is typically decided by the treating physician and can have a large effect on the cost of the service and the recovery time.

### SUMMARY

According to a first aspect, the disclosure provides a method for enhancing medical data to determine variation in cost of medical services. The method includes receiving a first set of medical episode data records, whereby the first set of medical episode data records are related to a plurality of medical episodes, and each of the plurality of medical episodes includes an associated patient, an associated physician, and an associated episode cost. The method further includes categorizing each of the plurality of medical episodes in the first set of medical episode data records according to a disease stage categorization rule, and assigning at least one comorbidity classification to each of the categorized medical episode data records. The method also applies at least one data enhancement rule to each of the first set of medical episode data records to form an enhanced set of medical episode data records. According to the disclosed method, the at least one data enhancement rule is related to a parameter of the associated patient for each of the plurality of medical episodes. The method includes identifying a first medical episode data record in the enhanced set of medical episode data records, wherein the first medical episode data record includes an associated first medical episode having a first type, a first associated physician and a first associated episode cost. The method also includes identifying a subset of the enhanced set of medical episode data records, wherein the subset of the enhanced set of medical episode data records includes a subset of associated medical episodes having the first type, a subset of associated physicians and a subset of associated episode costs, wherein the subset of the enhanced set of medical episode data records does not include the first medical episode data record. In addition, the disclosed method includes applying a regression analysis to the subset of associated episode costs to identify a mean episode cost, an upper confidence level episode cost and a lower confidence level episode cost, and comparing the first associated episode cost to the upper confidence level episode cost and the lower confidence level episode cost

According to another aspect, the disclosure provides a system for enhancing medical data to determine variation in cost of medical services. The system includes a data processing engine that is configured to receive a first set of medical episode data records. According to the disclosure, the first set of medical episode data records is related to a plurality of medical episodes, and each of the plurality of medical episodes includes an associated patient, an associated physician, and an associated episode cost. The data processing engine is further configured to categorize each of the plurality of medical episodes in the first set of medical episode data records according to a disease stage categorization rule. The data processing engine is further configured to apply at least one data enhancement rule to each of the first set of medical episode data records to form an enhanced set of medical episode data records, and the at least one data enhancement rule is related to a parameter of the associated patient for each of the plurality of medical episodes. The data processing engine is also configured to identify a first medical episode data record in the enhanced set of medical episode data records. According to the disclosure, the first medical episode data record includes an associated first medical episode having a first type, a first associated physician and a first associated episode cost. The data processing engine is also configured to identify a subset of the enhanced set of medical episode data records. The enhanced set of medical episode data records includes a subset of associated medical episodes having the first type, a subset of associated physicians and a subset of associated episode costs, and the subset of the enhanced set of medical episode data records does not include the first medical episode data record. In addition, the data processing engine is configured to apply a regression analysis to the subset of associated episode costs to identify a mean episode cost, an upper confidence level episode cost and a lower confidence level episode cost, and to compare the first associated episode cost to the upper confidence level episode cost and the lower confidence level episode cost.

In yet another aspect, the disclosure provides a computer program product for enhancing medical data to determine variation in cost of medical services. The computer program product includes a computer readable storage medium having program instructions embodied therewith whereby the program instructions are executable by a data processing engine. The program instructions cause the data processing engine to receive a first set of medical episode data records, wherein the first set of medical episode data records is related to a plurality of medical episodes, and wherein each of the plurality of medical episodes includes an associated patient, an associated physician, and an associated episode cost. The program instructions also cause the data processing engine to assign at least one comorbidity classification to each of the plurality of medical episodes in the plurality of medical episode data records, and to apply at least one data enhancement rule to each of the first set of medical episode data records to form an enhanced set of medical episode data records. According to the disclosure the at least one data enhancement rule is related to a parameter of the associated patient for each of the plurality of medical episodes. The program instructions of the computer program product also cause the data processing engine to identify a first medical episode data record in the enhanced set of medical episode data records, whereby the first medical episode data record includes an associated first medical episode having a first type, a first associated physician and a first associated episode cost. The program instructions also cause the data processing engine to identify a subset of the enhanced set of medical episode data records, whereby the subset of the enhanced set of medical episode data records includes a subset of associated medical episodes having the first type, a subset of associated physicians and a subset of associated episode costs. However, according to the disclosure, the subset of the enhanced set of medical episode data records does not include the first medical episode data record. The program instructions of the computer program product also cause the data processing engine to apply a regression analysis to the subset of associated episode costs to identify a mean episode cost, an upper confidence level episode cost and a lower confidence level episode cost, and to compare the first associated episode cost to the upper confidence level episode cost and the lower confidence level episode cost.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 depicts a schematic representation of a system for describing variation in cost by physician, according to an embodiment of the present disclosure;

FIG. 2 depicts a flowchart of a method for describing variation in cost by physician, according to an embodiment of the present disclosure;

FIG. 3 depicts an example of a medical episode data record, according to an embodiment of the present disclosure;

FIG. 4 depicts a pre-processing flowchart for processing medical episode data records, according to an embodiment of the present disclosure;

FIG. 5 depicts an example of a comorbidity mapping table, according to an embodiment of the present disclosure;

FIGS. 6A-6B depict examples of grouping schemes that may be used with embodiments described herein;

FIGS. 7A-7F depict example flowcharts applying rules to merge, filter and enhance data associated with medical episodes, according to an embodiment of the present disclosure;

FIGS. 8A-8E depict example data inputs, according to embodiments of the present disclosure;

FIG. 9 depicts another flowchart of a method for describing the variation in cost by physician, according to an embodiment of the present disclosure;

FIG. 10 depicts an exemplary table showing variation in cost by physician, according to an embodiment of the present disclosure; and

FIG. 11 depicts an exemplary schematic representation of a network environment in which aspects of the present disclosure may be implemented.

### DETAILED DESCRIPTION

The present disclosure provides a method and system to aggregate, filter, and enhance numerous disparate data sets to help explain the variance in the cost of various medical procedures, by treating physician. In particular, the disclosure provides rules to merge, filter and enhance the data in order to better understand differences in cost among physicians and to be able to optimize management of the healthcare system, such as a hospital system. According to some embodiments, the method builds and examines episode costs to take into account various parameters of a specific medical episode that may have an effect on the cost of the medical procedure. For example, in at least one case, the method enhances the data to take into account aspects of the patient (age, race, diagnosis-based measures, etc.); the type of case (e.g., total knee replacement, partial hip replacement, etc.); the treatment; and, how to and where the physician discharges the patient. As described in more detail below, according to embodiments described herein, after the data enhancements, the method computes each physician's average cost by episode type for a given place of care, such as a hospital, and then benchmarks the physician's average cost against a predictive model of the average cost for all physicians' at the same place of care performing similar episodes. Accordingly, aspects described herein facilitate predictive modeling of what a physician's cost should be, per episode type, at a given treatment location. If the physician's real average cost per episode is below a specified prediction confidence interval, the physician may be considered efficient compared to the benchmark model. Conversely, if the physician's real average cost per episode is above the specified prediction confidence interval, the physician may have be considered to have inefficiencies that can be addressed. The information may be used by healthcare systems as a starting point to find physicians that are high outliers in a specific bundled episode spend. With this information, healthcare systems can make healthcare decisions that have an effect on fiscal, operational, and staff (e.g. physician) efficiency to improve performance for bundled payment models, and to intervene where physicians may need more oversight.

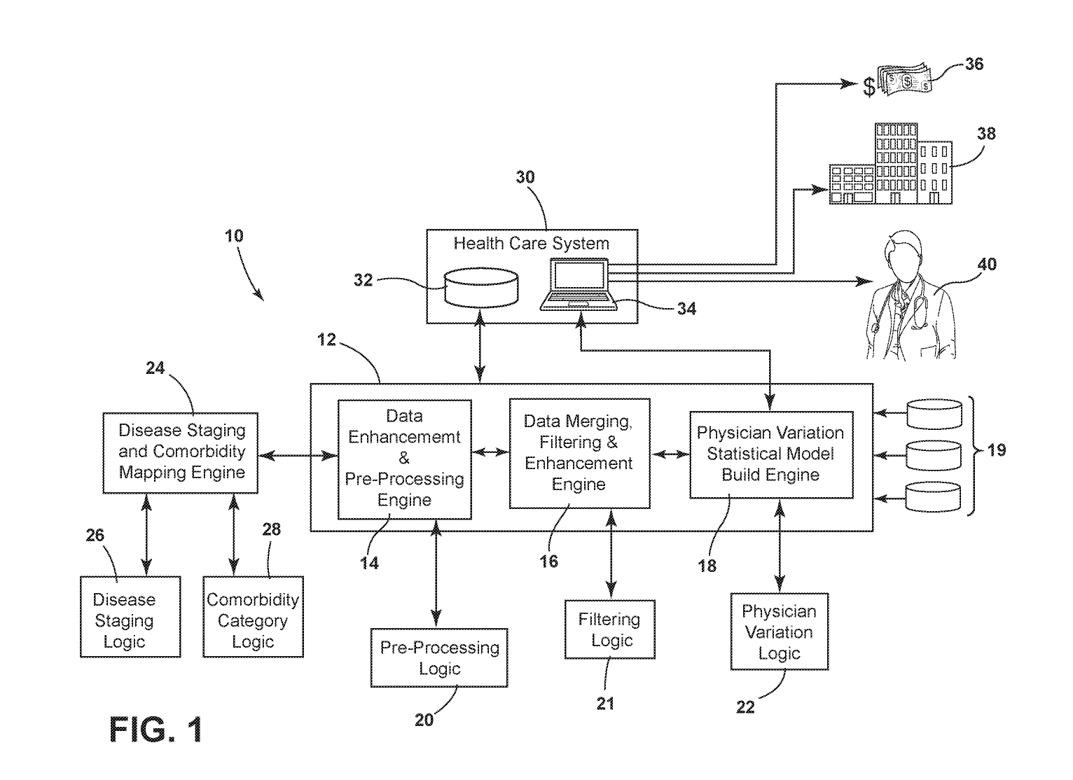

Referring to FIG. 1, a schematic representation of a system 10 for determining the variance in cost of a medical procedure by treating physician is shown. In accordance with an embodiment described herein, system 10 includes a data processing engine 12, which can include one or more sub-engines for enhancing, merging and filtering the data, as well as for building a prediction model. Data processing engine 12 may be coupled to a healthcare system 30, such as a hospital, healthcare provider, or other healthcare entity. Data processing engine 12 may also be coupled to one or more databases 19, as well as other data processing engines, such as a disease staging and comorbidity mapping engine 24, for mapping medical episodes to one or more severity stages and comorbidity factors, as explained in more detail below.

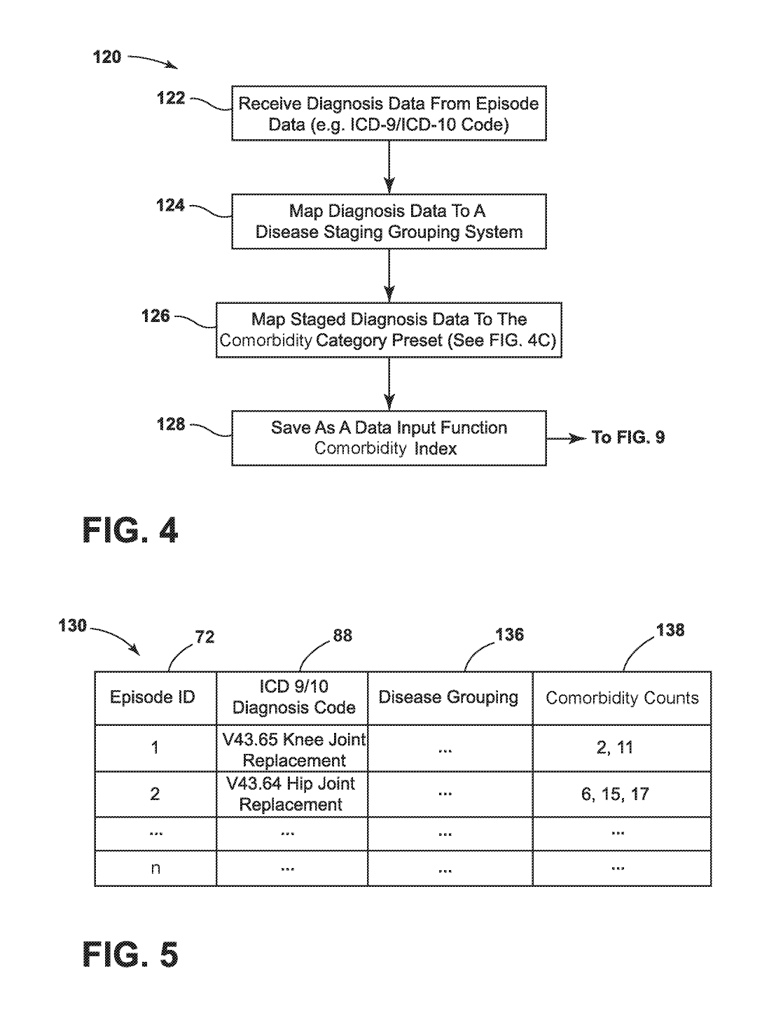

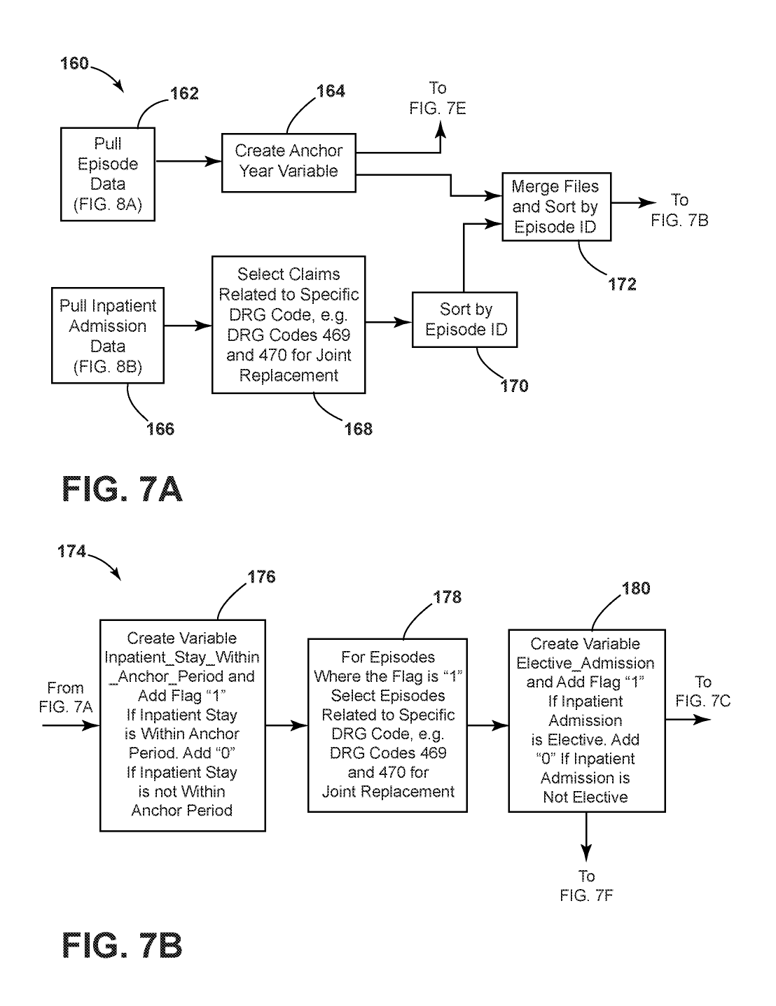

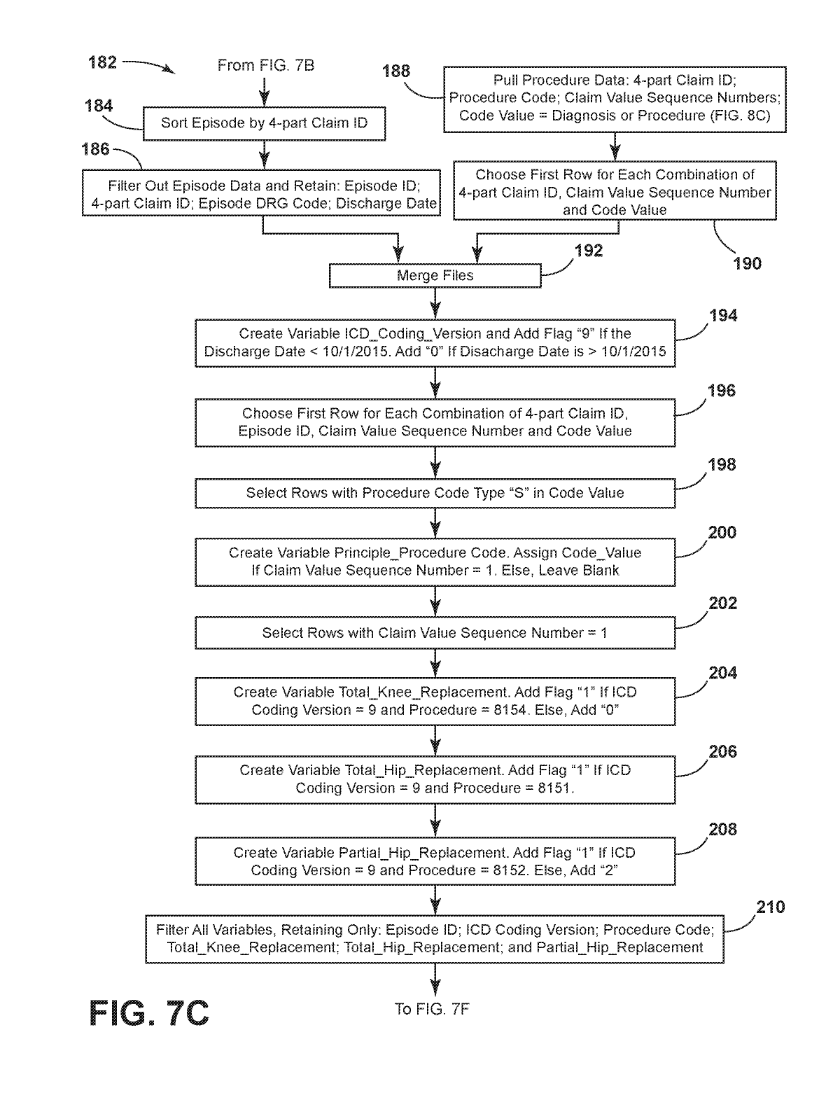

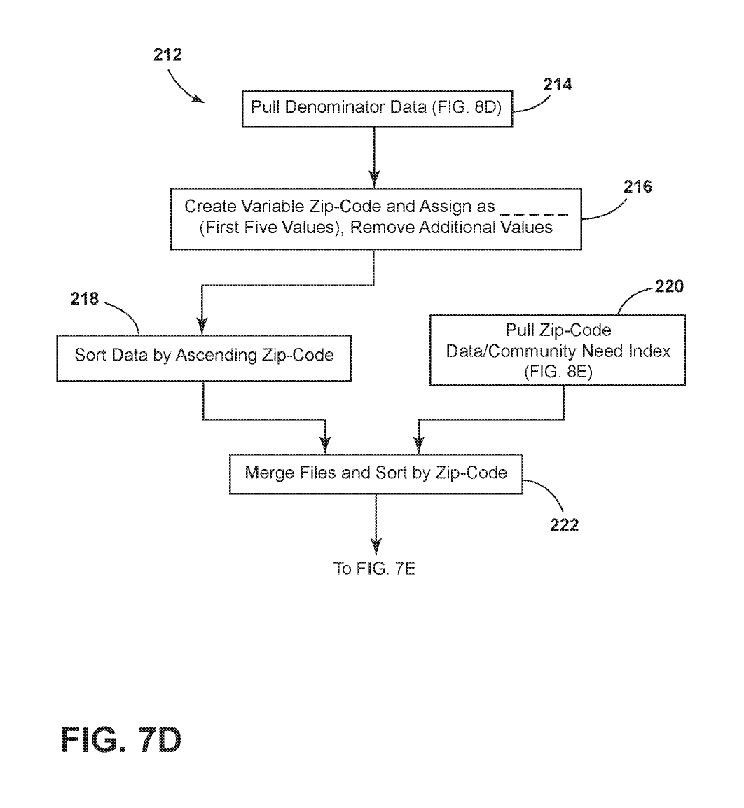

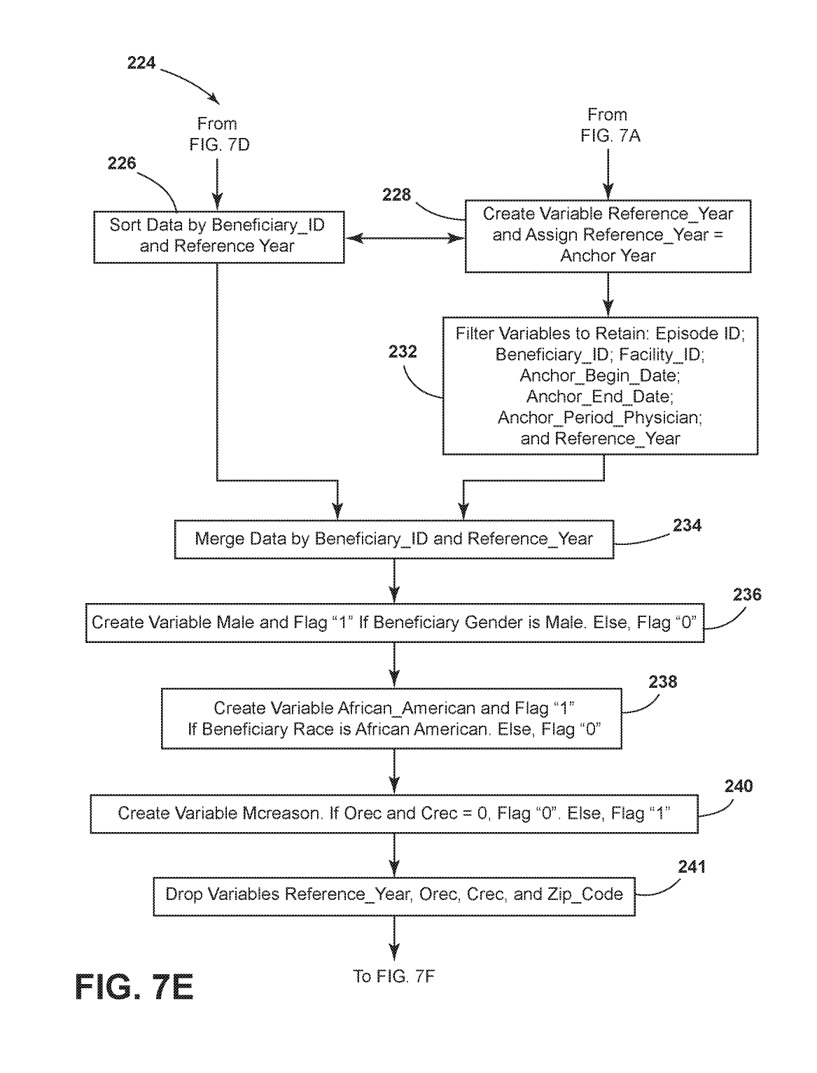

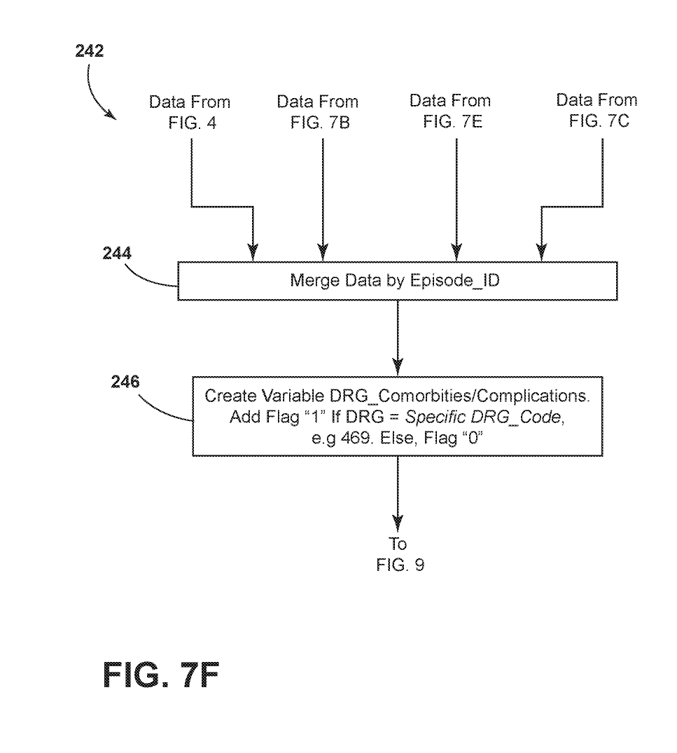

In at least one case, data processing engine 12 may be configured to receive medical episode data from a healthcare system 30, and specifically from one or more data stores 32 associated with healthcare system 30. Data processing engine 12 may include one or more functional sub-engines for separately enhancing and filtering the data, including, but not limited to, data pre-processing engine 14, data merging, filtering and enhancement engine 16, and statistical model build engine 18. Data pre-processing engine 14 may be configured to apply one or more rules to the episode data, including but not limited to pre-processing logic 20, as described in more detail below in relations to FIGS. 4A-6 in accordance with an embodiment of the disclosure. Data pre-processing engine 14 may also be coupled to disease staging and comorbidity mapping engine 24, applying disease staging logic 26 and comorbidity category logic 28 to the medical episode data. Data merging, filtering and enhancement engine 16 may be configured to apply filtering logic 21, as described in more detail below in relations to FIGS. 7A-7F in accordance with an embodiment of the disclosure. Physician variation statistical model build engine 18 may be configured to apply filtering logic 21, as described in more detail below in relations to FIG. 9, in accordance with an embodiment of the disclosure. Accordingly, data processing engine 12 may be configured to produce one or more outputs, variables, recommendations, or the like to healthcare management system 30 for making informed decisions on various aspects of healthcare system 30, including but not limited to decisions impacting the management of fiscal, facility, and physician resources.

As described in more detail below, data processing engine 12 may also include, or be coupled with, one or more database(s) to store information such as input variables and algorithms for implementing data processing rules. Accordingly, data processing engine 12 may receive and process the input variables based on the data processing rules. Data processing engine 12 may also include one or more servers including any processor, server (including a cloud server), mainframe computer, or other processor-based device capable of facilitating communication and running software programs or other applications.

With reference to FIG. 1, the illustrated embodiment depicts data processing engine 12 as being broken up into a plurality of functional sub-engines, including data pre-processing engine 14, data merging, filtering and enhancement engine 16, and statistical model build engine 18. However, it should be understood that all data processing engine function may be achieved in more or fewer sub-engines, such that any number of data processing engines may be programmed, configured, or connected to receive and transmit the same information or commands, and perform the same functionality as described with respect to the various sub-engines. For example, where there are descriptions regarding the respective separate functionalities of data pre-processing engine 14, data merging, filtering and enhancement engine 16, and statistical model build engine 18, such functionality may also be carried out by a single data processing device. In other words, in an embodiment that includes a data pre-processing engine 14, data merging, filtering and enhancement engine 16, and statistical model build engine 18, these sub-engines can be included within the same hardware component (and at the same geographic location) or in different hardware components (and at different geographic locations), and still fall within the spirit and scope of the present disclosure. As shown in FIG. 1, disease staging and comorbidity mapping engine 24, data pre-processing engine 14, data merging, filtering and enhancement engine 16, and statistical model build engine 18 may also be included in the same hardware as data processing engine 12, or may be communicatively connected in separate hardware. Input data may be stored in one or more data stores or databases, including data stores 32 and databases 19. Data stores 32 and databases 19 may be connected to data processing engine 12. In operation, one or more management devices 34 physically located in, or otherwise communicatively connected to, healthcare system 30, may receive results related to the variance in cost by physician from statistical model build engine 18. Healthcare system 30 may subsequently make fiscal decisions with respect to bundled payment services 36, apply operation changes 38 or implement improvements and efficiencies to physician practices 40.

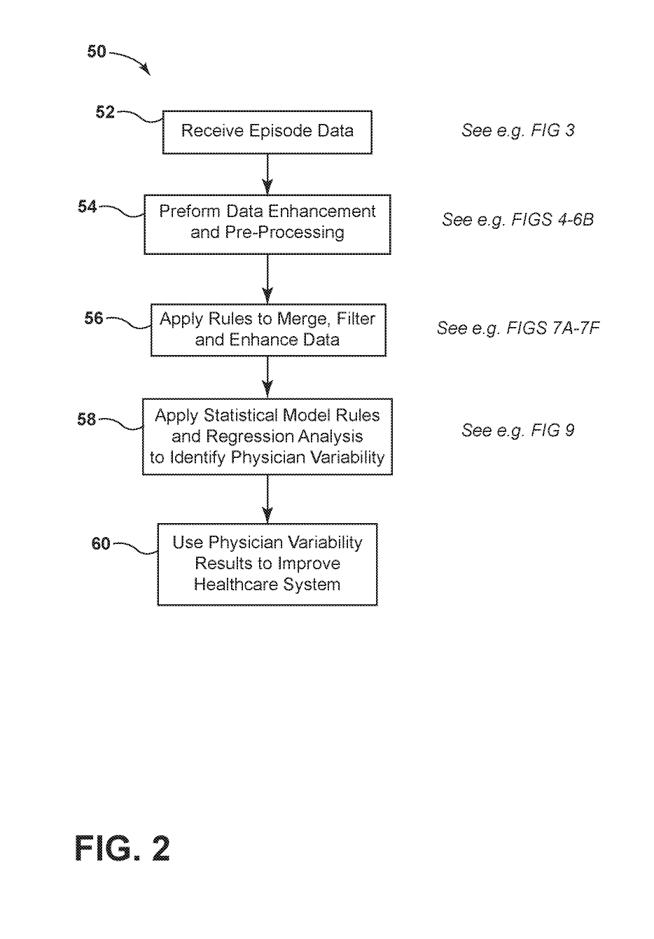

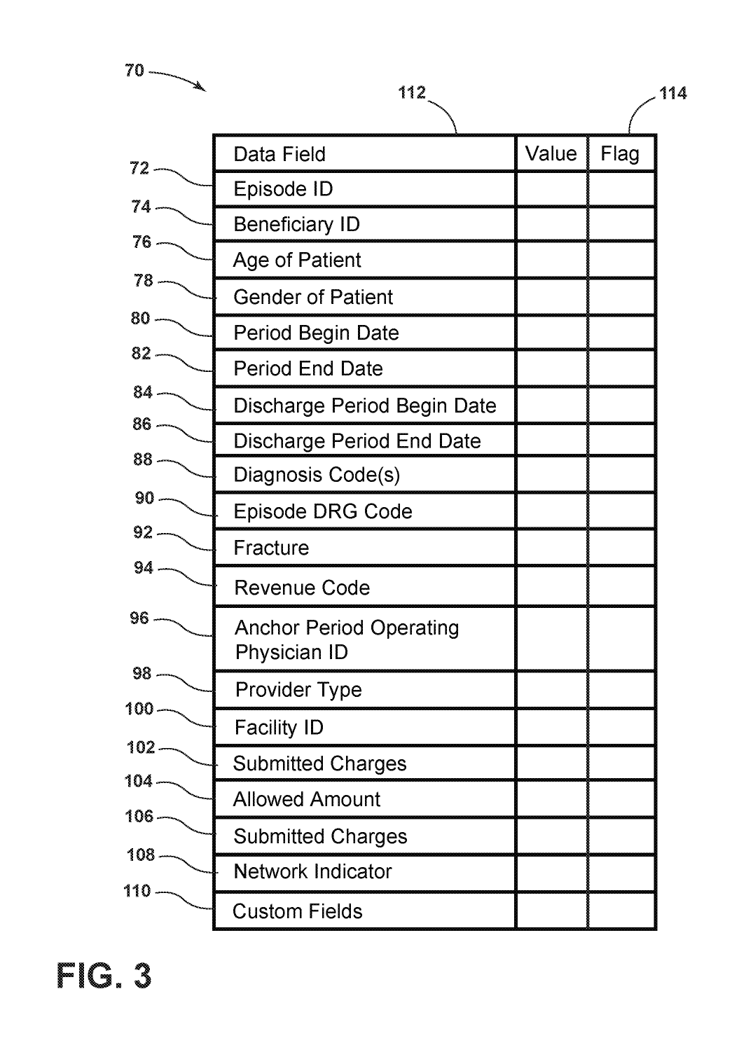

Accordingly, aspects of the present disclosure provide methods, systems and computer program products to receive input data in the form of medical episode record data; apply rules to merge, filter and enhance the data to account for various parameters related to the patient, the physician and the treatment location that may have an effect on the cost of the medical episode; and then assess a specific physician's cost across other physicians having similar parameters. In some cases, the disclosure provides rules that allow otherwise disparate data to be merged, merged, analyzed in a statistical model, the results of which may be used to facilitate healthcare system decisions. FIG. 2 depicts a flowchart 50 of an embodiment of an overall method for determining variation in cost by treating physician. According to an embodiment of the disclosure, at step 52, a server or other computer processor, such as data processing engine 12 of FIG. 1, may receive and use as input a plurality of medical episode data records. The medical episode data records may take a variety of forms and structures, and may include a variety of data fields, as further described below in relation to FIG. 3.

At step 54, various data pre-processing steps may be applied to the data received at step 52. For example, the medical episode data records may be mapped to one or more grouping schemes to further categorize the patient, the diagnosis, the treating physician, or other attributes, associated with each medical episode data record. In some cases, the medical episode data records may be mapped to indicate the severity of the medical episode, e.g. the disease stage, and/or the existence of comorbidities in a specific patient. In at least one case, as described in more detail in relation to FIGS. 4-6B, medical episode data records may be mapped to a disease staging categorization scheme, and further mapped to one of a plurality of functional comorbidity categories. The resulting comorbidity mappings may be used to help determine the variance in cost by treating physician.

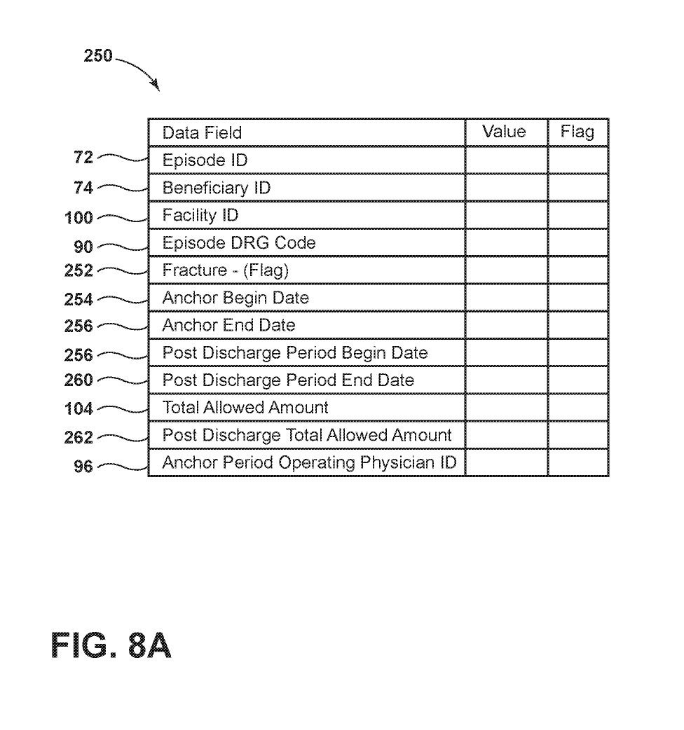

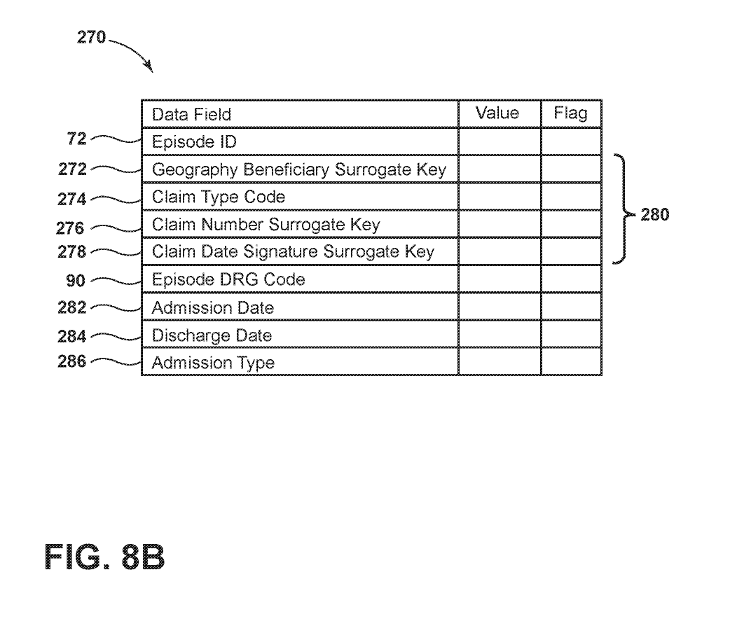

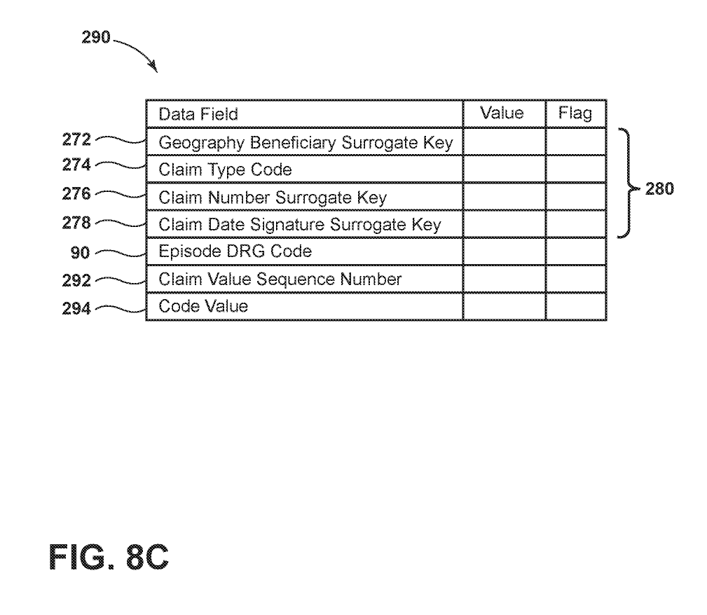

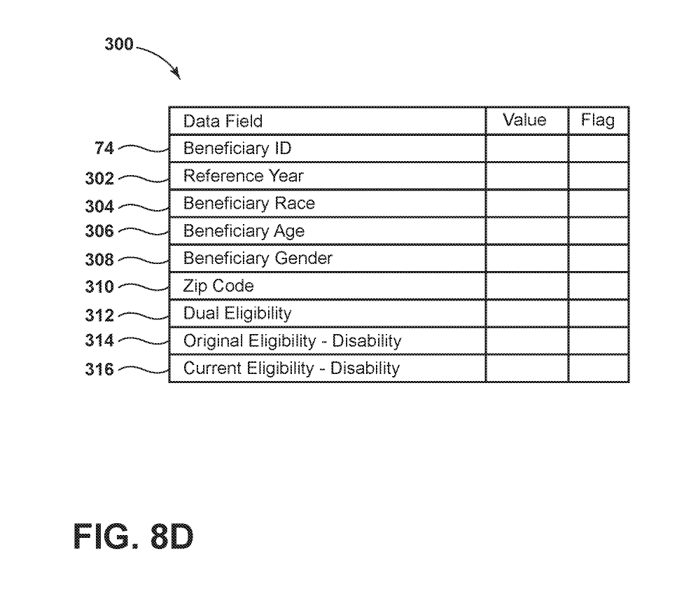

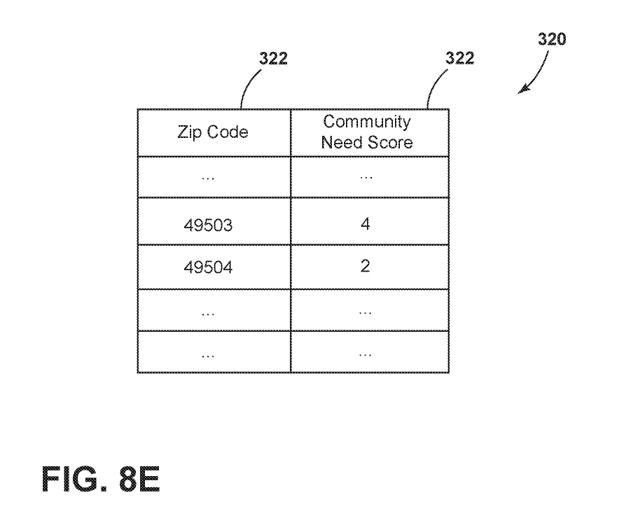

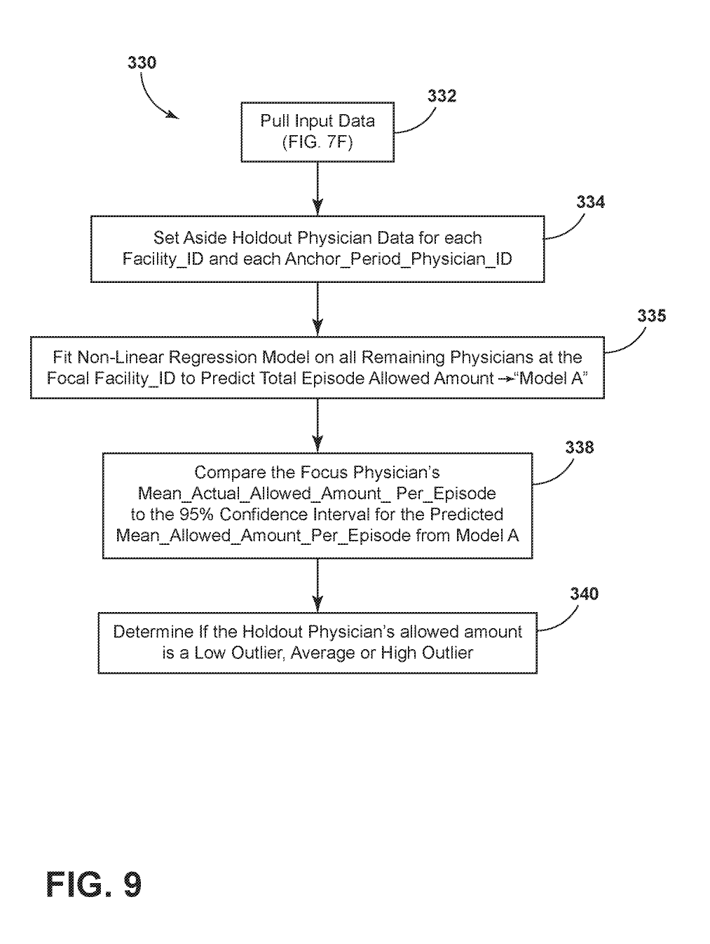

After the data enhancement and preprocessing at step 54, the method proceeds to step 56 and applies a number of rules to merge, filter and enhance various portions of the medical episode data records and the data associated with each record. For example, step 56 may include filtering out portions of the medical episode data records and merging the data with additional input files to further explain aspects of the input data. The method may also create new data variables associated with the medical episode data records. FIGS. 7A-7F, described in detail below, depict flowcharts describing process flows for merging, filtering and enhancing data of step 56, according to an embodiment contemplated herein. FIGS. 8A-8E also depict embodiments of various additional example data inputs.

Once the data in the medical episode data records has been merged, filtered and enhanced at step 56, at step 58 the process includes applying regression analysis to compare the enhanced medical episode data (steps 54 and 56) against one or more sets of historical medical episode data to determining variance in cost by treating physician. According to an embodiment described herein, step 58 may include the process flows depicted in FIG. 9 and further described below. At step 60, the results of the variation in cost by physician, identified at step 58, may be applied to improve one or more aspects of the healthcare system. For example, in some cases, the cost variation may inform areas for physician improvement in an effort to standardize physician costs as healthcare systems more to bundled payment formats. The overall process as depicted in FIG. 2 is described in more detail in the following sections.

Medical Episode Data Input

As set forth at step 52 of FIG. 2, according to some embodiments, an enhanced data processing server, such as data processing engine 12, may first receive medical episode data input, such as but not limited to, a plurality of medical episode data records from one or more data stores or databases, such as data stores 32 and database 19. Medical episode data records may represent one or more claims filed by a healthcare provider related to an encounter with the healthcare system. Such data records may include data regarding various components of a healthcare encounter, and may be stored in one or more flat or relational databases as would be understood by those skilled in the art. For example, a medical episode data record typically contains data related to the specific patient that was treated and/or to the healthcare system encounter to which the data record belongs. The type of data contained in the record, or associated with a specific record ID as in a relational database, may be dependent on the source of the data record, but may include data about one or more of the following: the patient; date(s) of service; diagnosis; procedure(s) performed; provider(s); place of service; charges; and other data related to the healthcare event or episode. In some cases, the data record may contain a number of standardized medical billing codes such as UB-04 revenue codes, ICD-9 diagnosis codes, CPT/HCPC procedure codes, and other standard codes as would be understood in the art. A medical episode data record may be provided by government agencies, private healthcare repositories, or other types of medical episode data stores.

In at least one embodiment, medical episode data input may be input as bundled episode data from the Centers for Medicaid and Medicare Services (CMS) for a specific healthcare system, such as medical episode data record 70 in FIG. 3. As depicted, medical episode data record 70 may contain one or more of the following data fields 112: an Episode ID 72 field; a Beneficiary ID 74 field; a patient age 76 field; a patient gender 78 field; an Anchor Period Begin Date 80 field (signifying the beginning date on which an anchor procedure started); an Anchor Period End Date 82 field; a Post-Discharge Period Begin Date 84 field; a Post-Discharge Period End Date 86 field; a diagnosis code 88 field; a procedure code field, or Episode Diagnosis Related Group (DRG) Code 90 field; a field signifying the presence of a fracture 92; a revenue code 94 field; an Anchor period operating physician ID 96 field; a physician type 98 field; a facility ID, such as a CMS Certification number (CCN), 100 field; an allowed amount 102 field; a post-episode total allowed amount 104 field; a submitted charges 106 field; a network indicator 108 field; and one or more custom fields 336. The medical claims data record may also contain a flag field 114 for further information or groupings to be made in relation to one or more of data fields 112. It should be understood, however, that the structure and format of the medical episode data input does not impact the spirit and scope of the present disclosure, and that medical episode data record 70 shown in FIG. 3 is only exemplary of the structure and format of the types of medical data input contemplated herein. Depending on the source of the medical episode data input, more or fewer fields may be present and the data record may be structured differently and may include additional data not specifically set forth herein.

Medical Data Input Preprocessing

According to aspects described herein, after the medical episode data input is received at step 52, as shown in FIG. 2, the data may be pre-processed to apply one or more categorization rules or schemes. In some cases, the categorization rules my help further identify the disease or diagnosis type for each medical episode data record, including but not limited to, the stage of the disease, the severity of the disease and any copending medical conditions for a specific patient that may have had an impact on the treatment, duration or outcome of the medical episode.

In at least one case the medical episode data records may be pre-processed to map them with one or more disease staging categories and one or more functional comorbidity categories. FIG. 4 depicts a flowchart 120 showing method steps for the pre-processing of medical episode data according to an embodiment described herein. At step 122, after medical episode data records, such as exemplary medical episode data record 70 of FIG. 3, are received, diagnosis data may be examined to determine the stage and/or severity of each medical episode. In some embodiments, ICD-9 and ICD-10 diagnosis code data may be examined, and at step 124, the diagnosis code data may be mapped to a disease staging categorization scheme.

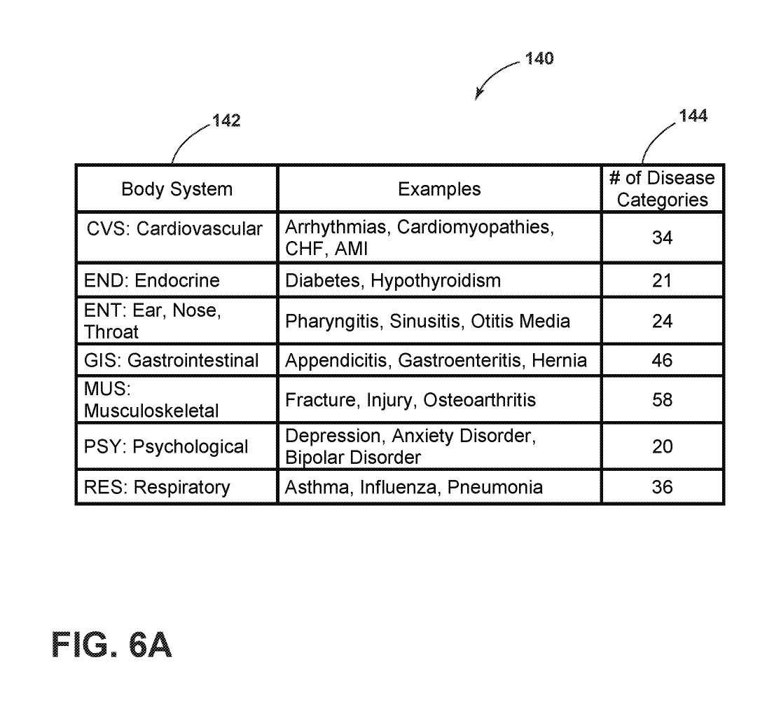

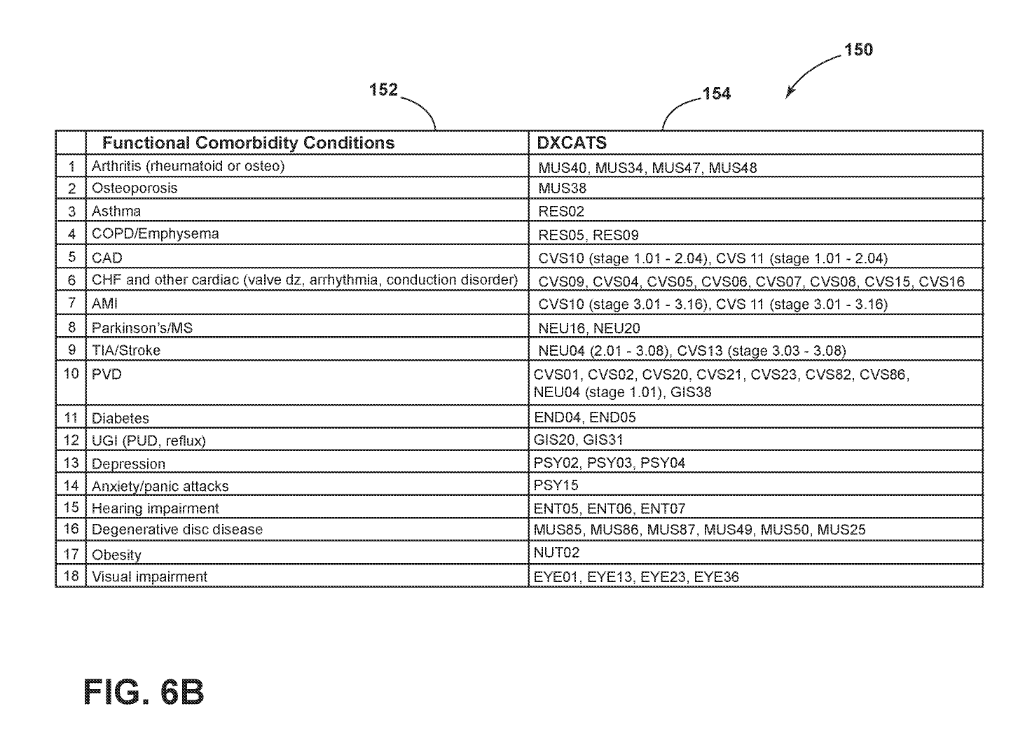

In at least one case, the medical claims data records may be assigned to a disease staging categorization scheme, such as the Disease Staging® classification system from Truven Health Analytics, Inc. Table 140 of FIG. 6A sets forth the basis of the Disease Staging® classification that groups all standard ICD-9/10 diagnosis codes into approximately 600 disease category groupings 142. The breakdown of the 600 groupings is shown by the “# of Disease Categories” 144. In the illustrated example grouping scheme of FIG. 6A, 34 of the approximately 600 groupings may constitute a CVS or cardiovascular “body system” disease category grouping 142. For example, an arrhythmia diagnosis would be assigned to the CVS or cardiovascular “body system” disease category grouping 142, and may be further categorized based on the disease stage or severity of the diagnosis. Referring to the example functional comorbidity index file 130 of FIG. 5 showing the FCI Counts, a disease categorization scheme 136 (depicted as unassigned in FIG. 5), such as a Disease Staging® category, may be associated with a particular Episode ID 72, ICD 9/10 diagnosis code 88, and one or more comorbidity counts 138 (described in more detail below).

Referring back to FIG. 4, in addition to the disease staging categorization grouping at step 124, at step 126 the process may map the disease-staged episode data to one or more categories describing co-pending conditions for each specific patient, or functional comorbidity. In at least one embodiment, the method includes rules for mapping associating each episode ID 72 with categories describing functional comorbidities that are present for the particular diagnosis. Chart 150 of FIG. 6B depicts a plurality of functional comorbidity conditions 152 which may be present in any given diagnosis. The functional comorbidity mapping may help explain, in addition to the disease staging categorization, the severity of a particular diagnosis for a particular patient. For example, a joint replacement surgery performed on a patient that suffers from diabetes (a comorbidity condition 11 in chart 150), may have required additional monitoring during the surgery and/or during recovery causing a longer episode duration.

Referring back to FIG. 4, at step 128, the medical episode data records, as mapped to a disease staging categorization scheme and one or more comorbidity categories, may be saved as a functional comorbidity index file 130, as shown in FIG. 5. The functional comorbidity index data may be used in determining variation in cost by physician, as described in more detail in relation to FIG. 9. FIG. 5 depicts an example FCI table disclosing disease staging category, diagnosis code, episode ID.

Enhancing Medical Input Data

Referring back to flowchart 50 in FIG. 2, at step 56 various rules may be applied to the medical episode data input to merge, filter, and enhance the data. More particularly, as part of the data enhancement and to facilitate building of a statistical model showing variability in cost by physician, certain portions of the medical episode data records may be extracted or merged with other portions of the data records. In addition, variables may be created to further describe aspects of a specific medical episode, and additional data input may be combined with the medical episode data records to further categorize, group, or describe the data.

FIGS. 7A-7F depict flowcharts describing a process for merging, filtering, and enhancing the medical episode data records for input to a regression analysis to identify physician variability (step 58) of FIG. 2, according to an embodiment described herein. For simplicity, and for purposes of describing various aspects included herein, the illustrated embodiment of FIGS. 7A-7F are described with respect to a particular medical episode, i.e., comprehensive joint replacement (CJR) episodes which may include, but are not limited to knee and hip replacements. However, the embodiments and techniques herein may be applied to many different types of episodes, and the disclosure is not limited to CJR episodes, nor to any other subset or type of medical episode. Furthermore, those skilled in the art will recognize that FIGS. 7A-7F represent only one embodiment of many encompassed by the present disclosure. For example, step 56 (FIG. 2) of flowchart 50 may include fewer or more steps than is depicted and described with respect to FIGS. 7A-7F or may substantially be ordered differently. Those skilled in the art will appreciate the alterations that may be made to the various processes described herein while still capturing the spirit of the present disclosure.

Referring first to FIG. 7A, flowchart 160 depicts steps that may be employed to merge, filter, and enhance medical episode data according to an embodiment of the disclosure described herein. According to the process, at step 162, data merging, filtering and enhancement engine 16 may receive a medical episode table including a set of medical episode data records from one or more databases, such as data store 32 or database(s) 19. FIG. 8A depicts a portion of an exemplary episode table input at step 162 according to an embodiment described herein. Specifically as shown in table 250, the following data may be initially pulled: episode ID 72; beneficiary ID 74; a facility ID (CCN) 100 (FIG. 3); an episode DRG code 90; a flag for presence of fracture 252; an anchor period begin date 254; an anchor period end date 256; a post-discharge period begin date 258; a post-discharge period end date 260; an episode total allowed amount 104 per anchor period (FIG. 3); a post-discharge total allowed amount 262; and an anchor period operating physician ID 96 (FIG. 3). As shown in FIG. 8A, data in episode table 250 may be referenced by episode ID 72. It will be understood, however, that FIG. 8A is only exemplary and other methods and formats of referencing various pieces of data related to medical episode data records may be used.

In at least some embodiments, variables may be created to help describe one or more medical episodes for a specific patient or beneficiary. For example, variables may be created to ensure that the correct demographic information is associated with the patient for a given point in time. Moving to step 164 in flowchart 160, in at least one case, an anchor year variable may be created based on the episode data table from step 162. The anchor year variable may be created for each episode ID 72 and used to signify the year that the medical episode took place, and, as shown in FIG. 7A, an anchor year variable may be used later (discussed below in relation to FIG. 7E).

At step 166, data merging, filtering and enhancement engine 16 may receive inpatient admission data as input from the medical episode data records. FIG. 8B depicts an example table of inpatient admission data pulled from a medical episode database, according to one embodiment. As shown in FIG. 8B, the inpatient admission data may also be referenced by episode ID 72, and may include Geography Beneficiary Surrogate Key 272, Claim Type Code 274, Claim Number Surrogate Key 276, and Claim Date Signature Surrogate Key 278, collectively, four-part claim ID 280; an episode DRG code 90; an admission date 282; a discharge date 284; and an admission type 286. In some cases, the four-part claim ID 280 may provide a unique ID for each specific medical episode.

At step 168 within the selected data all claims related to a specific DRG code may be selected to focus the analysis on a specific type of medical event. For example, using joint replacement procedures to simplify the description herein, DRG codes 469 and 470 may be selected from the inpatient admission data pulled at step 166. As is known in the art, DRG code 469 and 470 both refer to joint replacement procedures, and specifically, DRG code 469 refers to a joint replacement procedure with a presence of comorbidities, while DRG code 470 refers to a joint replacement procedure with an absence of comorbidities. Then, at step 170, the selected claims are sorted by episode ID 72 and the resultant files are merged with the anchor year variable created at step 164, as related to each episode ID 72. As described in more detail below, the merged files may be used as input in the flowchart 174 depicted in FIG. 7B.

FIG. 7B depicts flowchart 174, a carryon flowchart from flowchart 160 of FIG. 7A. At step 176, from the merged files created at step 172, a new variable, “inpatient stay within an anchor period,” may be created to describe whether there was an inpatient stay within an anchor period of the medical episode for each of the medical episode data records. According to an aspect of the disclosure, the value of the variable may constitute a flag, wherein if the inpatient stay is within the anchor year, the flag is set to “1,” and if the inpatient stay is not within the anchor year, the flag is set to “0.” Next, at step 178, for all episodes where the flag is set to “1,” i.e., the inpatient stay is within the anchor year, episodes are selected that are related to a specific DRG code. For example, according to the joint replacement example described herein, DRG codes 469 and 470 for joint replacement may be selected at step 178 in the method. According to aspects of the disclosure, by selecting the medical episodes from a specific DRG code (step 168) and those that required an inpatient stay, the variation in cost may be better understood.

In some embodiments, variables may be created that can be good predictors of medical procedural outcomes and costs. For example, when a patient elects to have a medical procedure, the patient may follow recovery instructions more closely and be more vested in a speedy and full recovery. In at least one embodiment, at step 180, a new variable “elective admission” may be created. The variable “elective admission” may also constitute a flag, wherein the flag is set to “1” if the inpatient admission was an elective procedure, i.e., a procedure that is initiated by the patient, and the elective admission variable is set to “0” if the inpatient admission is not elective. As shown in FIG. 7B, these variables are fed to process steps depicted in FIG. 7F as well as to process steps depicted in FIG. 7C.

With further reference to the illustrated embodiment, FIG. 7C provides flowchart 182 depicting further carryon steps to merge, filter, and enhance the medical episode data input. According to the embodiment, data and variables are carried over from flowchart 174 in FIG. 7B, and at step 184, the episodes are sorted by the four-part claim ID 290, described above. At step 186 certain episode data variables may be filtered out and certain episode data variables may be retained. Specifically, the episode ID 72 may be retained in reference to the four-part claim ID 290, the episode DRG code 90, and the discharge date 296. This data is merged at step 192 as described below.

In some cases, the method may include procedures to remove duplicate data entries from the medical episode data input. Backtracking to step 188, diagnosis and procedure data may be pulled from the medical episode data input to create a separate input table. Specifically, according to an embodiment of the disclosure and referencing FIG. 8C, a diagnosis procedure table may be built using the four-part claim ID 290, the episode DRG code 90, a claim value sequence number 292, and a code value 294, all of which help identify a specific diagnosis and procedure. At step 190, the first row for each combination of four-part claim ID 290, claim value sequence number 292, and code value 294, is selected. At step 192, the data file created at step 190 and the data retained at step 186 are merged together for further processing.

According to aspects described herein, indicator variables may be created to help predict cost variance. For example, steps 194-208 in FIG. 7C depict example variable that may be created as procedural and cost predictors in the illustrated embodiment of joint replacement medical episodes. At step 194, from the merged files at step 192, a new variable, “ICD coding version,” may be created at step 194. The “ICD coding version” variable may refer to whether the ICD code indicates the ICD coding version 9 or ICD coding version 10. Accordingly, if the discharge date is before Oct. 1, 2015 a flag “9” is added, and if the discharge date is after Oct. 1, 2015 a flag “0” is added. At step 196, the first row for each combination of four-part claim ID 290, episode ID 72, claim value sequence number 292, and code value 294 is chosen. At step 198, the rows with a procedure code type “S” in the code value are selected. At step 200 another variable may be created, “principle procedure code.” The “principle procedure code” variable may be assigned to the same value as the code value if the code value sequence number is “1.” However, if the code value sequence value is anything but “1,” the value for the “principle procedure code” may be left blank.

At step 202, rows with the claim value sequence number “1” are selected. Next, at steps 204-208, one or more variables may be created that are related to the specific DRG code. For example, at step 204a variable, “total knee replacement,” may be created. The “total knee replacement” variable may be indicated as a flag, and if the ICD coding version is “9” and the value for the procedure code is “8154,” then the flag may be set as “1,” however, for any other coding version or procedure version, the flag may be set as “0.” Similarly, at step 206, the variable, “total hip replacement,” may be created. The “total hip replacement” variable is specified as a flag, and if the ICD coding version is “9” and the value for the procedure code is “8151,” the flag may be set at “1.” At step 208, yet another variable, “partial hip replacement,” may be created and, again, specified with a flag. For the variable “partial hip replacement,” if the ICD coding version is “9” and the value of the procedure code is “8152,” then the flag may be set as “1.” However, if the ICD coding version is anything other than “9” and the value of the procedure code is anything other than “8152,” the flag may be set at “2.”

At step 210, all variables may be filtered again to avoid the creation of duplicate copies of variables. Specifically, at step 210, according to embodiments described herein, only the following variables may be retained: episode ID 72; ICD coding version; procedure code; total knee replacement; total hip replacement; and partial hip replacement are retained. It should be noted again, that in the illustrated embodiment, for purposes of explanation, the variables are related to CJR episodes. However, it should be understood that for other types of episodes, different types of variables may be created to describe the specific DRG code, and those skilled in the art will readily contemplate the various procedural and cost predictors related to other types of medical episodes. As shown in FIG. 7C, the process proceeds to the flowchart depicted in FIG. 7F.

Referring to FIG. 7D, flowchart 212 depicts the input of additional data and data files, including demographic data, according to embodiments of the present disclosure. Specifically at step 214, an additional data input, Denominator Data (e.g., demographic data), a sample of which is depicted in FIG. 8D, may be received by data merging, filtering and enhancement engine 16. With reference to FIG. 8D, the data input may include variables contained with the medical episode data records or contained in additional data files associated with the one or more episode IDs in the medical episode data records. These variables may include demographic data, including, but are not limited to: beneficiary ID 74; reference year 302; beneficiary race 304; beneficiary age 306; beneficiary gender 308; zip code 310; a variable, “dual eligibility,” 312, which may refer to the patient is eligible for both Medicare and Medicaid; a variable flag related to whether an original Medicare eligibility reason for the patient is in force, “ORCE” 314; and a variable flag related to whether a new Medicare eligibility reason for the patient is in force, “CRCE” 316. After step 214, the process proceeds to step 216 where a new zip code variable, “zip code,” is created and may be assigned the first five values of the zip code 310 pulled from the medical episode data record at step 214. At step 218 the data is sorted by ascending zip code. The data sorted by ascending zip code may be merged with files pulled at step 220, described in more detail below, and again sorted by zip code at step 222. In at least some embodiments, the steps of FIG. 7D create input variables for use in the non-linear regression process described in more detail below.

The filtered medical episode data may also be cross-referenced to a measure for a specific community's access and/or barriers to healthcare. Some communities experience significant barriers to healthcare which can have an effect on the severity of the episode that is being treated, the outcome of the treatment, and other aspects of the episode care. For example, treating an episode in a community that is predominantly a non-native language speaking community may present barriers that effect, for example, the length of the treatment and specific follow-up actions. The system may use various types of community assessment information, such as governmental census information or CMS data. In other cases, the system may use proprietary sources of community assessment data. In at least one case, the system may attribute a score level, such as a score from 1 to 5, to areas based on zip code throughout the United States. FIG. 8E depicts an excerpt of a sample community need index table 320, according to some embodiments described herein. As shown in FIG. 8E, a community need index mapping may contain a location reference 322, such as a zip code, or other location reference, and provide a level of barrier to healthcare 324. In an embodiment of the disclosure, a high score may indicate a community having significant barriers to healthcare, and a low score may indicate a community having very few barriers to healthcare. For example, in at least one case, significant barriers to healthcare may be mapped as a “5” and little to no barrier to healthcare may be mapped as a “1.” Levels of barriers to healthcare falling in between significant (“5”) and little to no (“1”), may be mapped as “2,” “3,” or “4.

Accordingly, referring again to FIG. 7D, a community need index table, such as table 320 of FIG. 8E, may be pulled and merged with the sorted data of step 218. In particular, the data sorted by ascending zip code at step 218 is given a community need index score or is referenced with a community need index score at step 222. After step 222 the process proceeds to the steps in flowchart 224 of FIG. 7E.

FIG. 7E depicts a flowchart 224, depicting the flow of process data from the flowchart 212 of FIG. 7D and flowchart 160 of FIG. 7A. Specifically, at step 226, the data file created at step 222 may be sorted by beneficiary ID 74 and a new variable, “reference year.” This data may eventually be merged with data variables retained in step 232, described in more detail below. At step 228, input data files created at step 172 of flowchart 160 may be used to create a new variable, “reference year” (shared with step 226) which may be assigned to the same value as the anchor year variable. At step 232 the variables may be again filtered, with at least the following variable being retained: episode ID 72; beneficiary ID 74; facility ID (CCN) 100; anchor period begin date 254; anchor period end date 256; anchor period operating physician ID 96; and reference year. At step 234 the data from step 226 and the retained variables from step 232 may be merged by beneficiary ID and reference year.

In some cases, additional variables may be created that identify the patient by various parameters that may have an effect on the type and duration of the medical episode. For example, for some types of medical episodes, gender, race as well as the underlying reason for Medicare eligibility may have bearing on medical procedure outcomes, complexity and cost. For example, statistics indicate that some patients may have lower access to home care and therefore worse recovery times or higher readmissions. According to some embodiments, at step 236, a variable, “male,” may be created, and assigned a flag of “1” if the beneficiary gender is male, otherwise assigned a flag of “0.” At step 236a variable, “African American,” may be created, and assigned a flag of “1” if the beneficiary race is African American, otherwise assigned a flag of “0.” At step 240 the variable, “Mcreason” may be created and assigned a flag “0” if the variables “OREC” and “CREC” have a value of “0,” and otherwise, assigned a flag “1.” At step 241, according to some embodiments, the variables reference year, OREC, CREC, and zip code may be dropped from the data file. The process then moves to flowchart 242 of FIG. 7F.

FIG. 7F depicts a final flowchart of the data filtering, merging, and enhancement processes according to the illustrated embodiment. Specifically in flowchart 242, the functional comorbidity index file 130 (FIG. 4) may be merged with the data created at step 180 (FIG. 7B), the data created at step 241 (FIG. 7E), and the data created at step 210 (FIG. 7C). All of these pieces of data may be merged by episode ID at step 244. More particularly, step 244 creates a data set having various parameters of the episode data records mapped to the functional comorbidity index file created at step 128 (FIG. 4). From this data, at step 236, a variable, “DRG comorbidities and complications,” may be created. The variable may be assigned a flag “1” if the DRG is the same as the specific DRG code (e.g., DRG code 469). Otherwise the variable may be assigned a flag “0.” The data created at step 246 may be used in the statistical model building steps described below with reference to FIG. 9.

Apply Rules to Identify Cost Variance

As previously stated, aspects described herein facilitate analytics to identify variations in total allowed costs by physicians at a specific healthcare facility, such as a hospital. More specifically, the process includes provisions to identify significantly predicted patient characteristics along with physician-level effects on costs. For example, the model allows for indicators such as a patient's functional comorbidities and physician-specific contributors, to be attributed to the overall cost of a medical episode. In at least some embodiments, the model will allow for outlier physicians, i.e, physicians showing particularly high or low costs for standard medical procedures, to be highlighted. Accordingly, for each focus physician, the model provides a regression system where, for a focus physician, that physician's data is compared to a model of all other physicians' data for the same procedure at the same facility. The other physicians' data may be used to model and predict spend for the focus physician, which may be conditional on patient indicators, e.g. functional comorbidities, stage level, or other variables specific to a patient's diagnosis and treatment, as well as physician-specific contributors, e.g., how and to what type of facility a patient is discharged.

According to aspects described herein, the model provides for a confidence interval prediction and thus the ability to classify the actual spend of the focus physician as a high or low outlier. In other words if the focus physician cost is above a certain confidence interval, such as but not limited to a 95% confidence interval, the focus physician would be a high outlier. Conversely, if the focus physician cost is below the confidence interval, e.g. a 95% confidence interval, the focus physician would be a low outlier. Flowchart 330 of FIG. 9 depicts the process for comparing and benchmarking variants in physician cost according to an aspect described herein. Specifically, the system provides a statistical model building process for identifying variance in physician cost which may be applied in one or more healthcare systems to realize cost savings and other operational efficiencies.

According to an embodiment of the disclosure, at step 332, the physician variation statistical model build engine 18 (FIG. 1) may receive input data created at step 246 of FIG. 7F. At step 334, the physician variation statistical model build engine 18 may identify a focus physician for analysis, and the focus physician's data is set aside for each facility ID 100 and each anchor period.

At step 335a non-linear regression model on all remaining physicians' data for the focus facility ID 100 may be fitted to predict a total episode allowed amount, using the focus physician's peers as well as the focus physicians case mix (i.e., same types of episodes, patient comorbidities, complexities, as well as other physician case mix indicators known in the art), e.g. “Model A.” In some cases, data on all other physicians may be pulled from the same database used to create the focus physician data set. However, in cases where there is not enough data from other physicians, similar data from historical medical databases having historical episode data records for the same facility ID 100 may be used to create “Model A.”

At step 338 the focus physician's mean actual allowed amount per episode is compared to the selected confidence interval for the predicted allowed mean amount per episode from “Model A.” Then, at step 340, as described above, it is determined if the focus physician's allowed amount is a low outlier, an average outlier, i.e., within the selected confidence interval, or a high outlier. As would be understood in the art, a model prediction typically exhibits a 95% confidence interval based on uncertainty about the model coefficients due to factors, including but not limited to sampling error and uncertainty about future outcomes. Accordingly, to account for the uncertainty, the focus physician's actual mean cost per episode may be compared to the 95% model prediction interval (PI). If the focus physician's mean cost is lower than the 95% PI, the focus physician may be identified as a low outlier. Conversely, if the focus physician's mean cost is above the 95% PI, the focus physician may be identified as a high outlier. Otherwise, the focus physician may be identified to be in line with his peers.

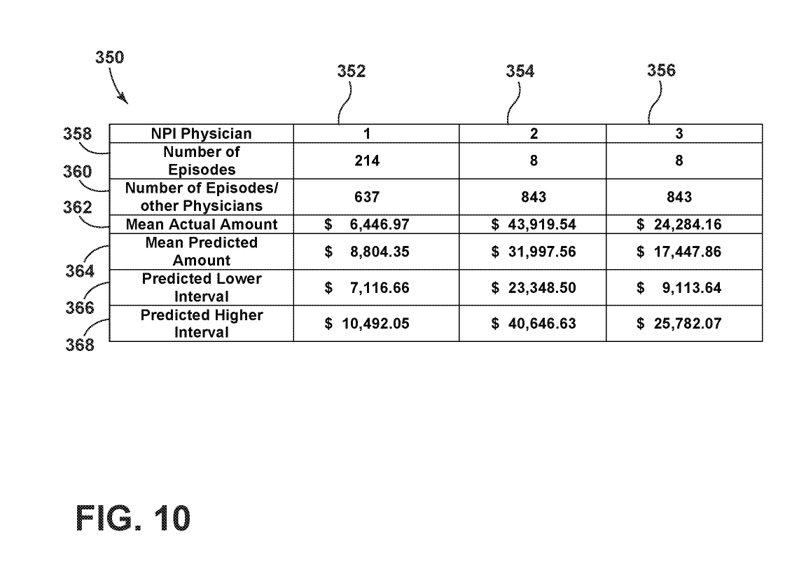

FIG. 10 depicts example results, i.e. table 350, of the data merging, filtering, enhancing and subsequent statistical modeling of medical episode data records, according to embodiments described herein. Table 350 depicts data for three different physicians: physician 1 in column 352; physician 2 in column 354; and physician 3 in column 356. For each physician, the following data sets are presented: number of episodes for the focus physician 358 for a particular episode ID at a particular facility ID; number of episodes for all other physicians 360 for the same particular episode ID at the same particular facility ID; the mean actual amount 362 for the focus physician for the particular episode ID; the mean predicted amount 364 for all other physicians for the particular episode ID; the predicted lower confidence interval 366 for the particular episode ID; and the predicted higher confidence interval 368 for the particular episode ID.

As shown in table 350, physician 1 represents a low outlier according to methods described herein because the physician's mean actual amount ($6,446.97) is lower than the predicted lower confidence interval 366 for physician 1 ($7,116.66). Specifically, according to the data, physician 1 consistently treats patients for the particular episode ID type at a lower cost, and more efficiently, than other physicians at the same facility. Accordingly, physician 1 may be used as a model for identifying techniques and efficiencies for other physicians when making decisions for bundled payments, e.g. in identifying successful treatment plans and discharge locations.

Conversely, physician 2 represents a high outlier according to methods described herein because the physician's mean actual amount ($43,919.54) is higher than the predicted higher confidence interval 368 for physician 2 ($40,646.63). Specifically, according to the data, physician 2 consistently treats patients for the particular episode ID type at a higher cost than other physicians at the same facility. Accordingly, physician 2 may be identified as a source for improvement, to help lower costs for bundled payment services.

Physician 3 represents an average cost model according to methods described herein because the physician's mean actual amount ($24,284.16) falls between the predicted lower confidence interval 366 and the predicted higher confidence interval 368 for physician 3. Specifically, according to the data, physician 3 consistently treats patients for the particular episode ID for about the same cost as other physicians at the same facility. Accordingly, physician 3 may be identified as a physician not requiring intervention.

Exemplary Operating Environment

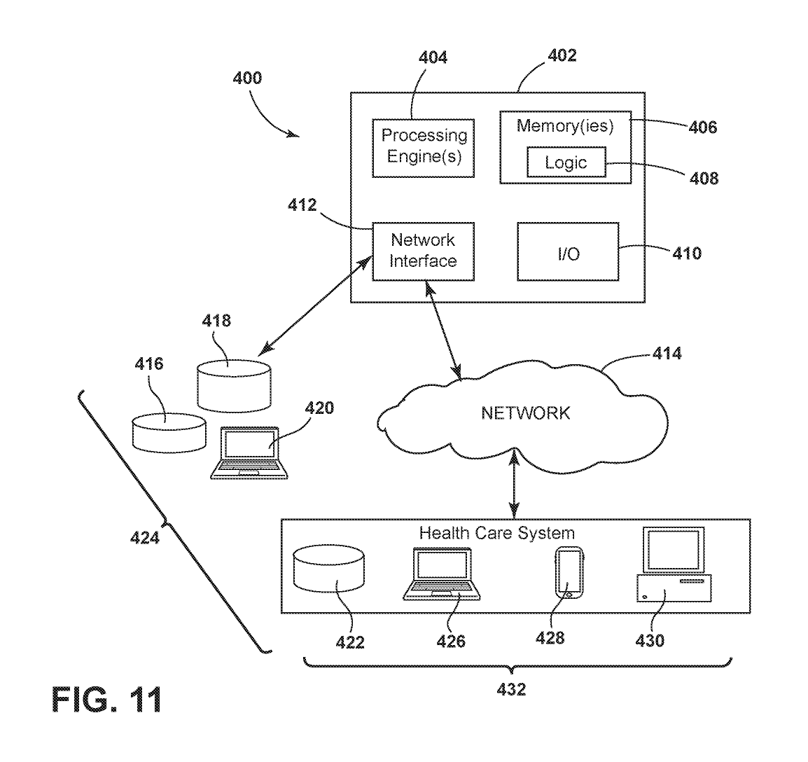

Embodiments of the methods and system described herein may utilize various computer software and hardware components, including but not limited to, servers, mainframes, desktops computers, databases, computer readable media, input/output devices, networking components and other components as would be known and understood by a person skilled in the art. FIG. 11 illustrates a networked operating environment 400 in which aspects of the present disclosure may be implemented, according to embodiments described herein. It should be understood, however, that environment 400 is only one example of a suitable environment for implementing methods described herein and is not intended to suggest any limitation as to the scope or functionality of the present disclosure. As depicted, environment 400 may include one or more servers 402, one or more databases 416, 418, 420 and 422, collectively, databases 424, and one or more access devices, such as computer/laptop computer 426, handheld device 428 and enterprise device 430, collectively access devices 432. Components of environment 400 may also be communicatively connected to one or more networks, such as network 414, for communication between the components.

Server 402 is generally representative of one or more servers suitable for processing medical claims data and serving data in the form of webpages or other markup language forms with associated applets, ActiveX controls, remote-invocation objects, or other related software and data structures, to service clients of various “thicknesses.” Server 402 may be configured as would be known by a skilled artisan and may include one or more processing engines 404, memory 406, one or more network interfaces 412, one or more input/output devices 410 (such as a keyboard, mouse, display, etc.). Memory 406 may include a logic module 408 for processing medical claims data. In some embodiments, processing engine 404 may include one or more local or distributed processors, controllers, or virtual machines. As described above in relation to FIG. 1, processing engines 404 may include multiple processing engines such as disease staging and comorbidity mapping engine 24, data pre-processing engine 14, data merging, filtering and enhancement engine 16, and statistical model build engine 18.

As would be understood in the art, processing engine 404 may be configured in any convenient or desirable form as would be known by a skilled artisan. Memory 406 may comprise one or more electronic, magnetic, or optical data-storage devices, and may include different types of memory. As would be known in the art, memory 406 may store instructions, such as logic module 408, for processing by processing engine 404. As described above in relation to FIG. 1, logic module 408 may include multiple logic modules such as any one of disease staging logic 26, comorbidity category logic 28, pre-processing logic 20, filtering logic 21 and physician variation logic 22. Logic module 408 may include machine readable and/or executable instructions sets for performing and/or facilitating performance of methods and rendering graphical or tabular user interfaces as further described herein, including sharing one or more portions of this functionality in a client-server architecture, over a wireless or wireline communications network 414 with one or more access devices 432. The logic may be embodied in a variety of known software systems, including but not limited to, SPSS, SAS® and Java®.

Databases 424 may include one or more electronic, magnetic, optical data-storage devices, or other data-storage devices which can include or are otherwise associated with respective indices (not shown). In some embodiments, databases 424 include medical, drug, and lab-related medical claims data. In other embodiments, databases 424 include and/or extract healthcare administrative data, such as medical claims and encounter data, from health plan, employer and government databases. In some embodiments, databases 424 additionally include medical guidelines data sources, such as government and/or other public sources, government regulations and proprietary databases. According to aspects described herein, databases 424 may be connected to server 402 via network 414.

Server 402 may be accessed by one or more access devices, including, but not limited to, personal computers, enterprise workstations, handheld devices, mobile telephone, or any other device capable of providing an effective user interface with a server or database. As depicted, in an embodiment of the disclosure, server 402 is connected to one or more access devices 432 via network 414. Network 414 may be any type of data communications network known in the art, including, but not limited to a LAN, WAN, public-switched, satellite, or any other type of network as would be contemplated by a skilled artisan.

Accordingly, the present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for enhancing medical data to determine variation in cost of medical services comprising:
receiving, by a data processing engine, a first set of medical episode data records, wherein the first set of medical episode data records is related to a plurality of medical episodes, and wherein each of the plurality of medical episodes includes an associated patient, an associated physician, and an associated episode cost;
categorizing, by the data processing engine, each of the plurality of medical episodes in the first set of medical episode data records according to a disease stage categorization rule;
assigning, by the data processing engine, at least one comorbidity classification to each of the categorized medical episode data records;
applying, by the data processing engine, at least one data enhancement rule to each of the first set of medical episode data records to form an enhanced set of medical episode data records, wherein the at least one data enhancement rule is related to a parameter of the associated patient for each of the plurality of medical episodes;
identifying, by the data processing engine, a first medical episode data record in the enhanced set of medical episode data records, wherein the first medical episode data record includes an associated first medical episode having a first type, a first associated physician and a first associated episode cost;
identifying, by the data processing engine, a subset of the enhanced set of medical episode data records, wherein the subset of the enhanced set of medical episode data records includes a subset of associated medical episodes having the first type, a subset of associated physicians and a subset of associated episode costs, wherein the subset of the enhanced set of medical episode data records does not include the first medical episode data record;
applying, by the data processing engine, a regression analysis to the subset of associated episode costs to identify a mean episode cost, an upper confidence level episode cost and a lower confidence level episode cost; and
comparing, by the data processing engine, the first associated episode cost to the upper confidence level episode cost and the lower confidence level episode cost.

2. The method of claim 1, further comprising:
determining, by the data processing engine, that the first associated physician has a high episode cost when the first associated episode cost is above the upper confidence level episode cost.

3. The method of claim 1, further comprising:
determining, by the data processing engine, that the first associated physician has a low episode cost when the first associated episode cost is below the lower confidence level episode cost.

4. The method of claim 1, further comprising:
building, by the data processing engine, a comorbidity classification file based on the assigned comorbidity classification to each of the categorized medical episode data records.

5. The method of claim 4, further comprising:
applying, by the data processing engine, the comorbidity classification file to the enhanced set of the plurality of medical episode data records prior to applying the regression analysis.

6. The method of claim 1, wherein the step of applying, by the data processing engine, at least one data enhancement rule to each of the plurality of medical episodes data records to form an enhanced set of the plurality of medical episode data records, wherein the at least one data enhancement rule is related to a parameter of the associated patient for each of the plurality of medical episodes, further comprises:
selecting, by the data processing engine, only the medical episodes data records from the plurality of medical episode data records having a first diagnosis code.

7. The method of claim 1, wherein the step of applying, by the data processing engine, at least one data enhancement rule to each of the plurality of medical episode data records to form an enhanced set of the plurality of medical episode data records, wherein the at least one data enhancement rule is related to a parameter of the associated patient for each of the plurality of medical episodes, further comprises:
categorizing, by the data processing engine, each of the plurality of medical episode data records based on a zip code of the associated patient.

8. The method of claim 6, wherein the step of applying, by the data processing engine, at least one data enhancement rule to each of the plurality of medical episode data records to form an enhanced set of the plurality of medical episode data records, wherein the at least one data enhancement rule is related to a parameter of the associated patient for each of the plurality of medical episodes, further comprises:
creating, by the data processing engine, a variable related to the first diagnosis for each of the plurality of medical episode data records.

9. The method of claim 1, wherein the data processing engine comprises a data merging, filtering and enhancement engine, and wherein the data merging, filtering and enhancement engine performs the process of applying at least one data enhancement rule to each of the plurality of medical episode data records to form an enhanced set of the plurality of medical episode data records, wherein the at least one data enhancement rule is related to a parameter of the associated patient for each of the plurality of medical episodes.

10. The method of claim 1, wherein the data processing engine comprises a physician variation statistical model build engine, and wherein the physician variation statistical model build engine performs the process of applying a regression analysis to the subset of associated episode costs to identify a mean episode cost, an upper confidence level episode cost and a lower confidence level episode cost.

11. The method of claim 10, wherein the physician variation statistical model build engine performs the process of comparing the first associated episode cost to the upper confidence level episode cost and the lower confidence level episode cost.

12. A system for enhancing medical data to determine variation in cost of medical services comprising:
a data processing engine configured to:
receive a first set of medical episode data records, wherein the first set of medical episode data records is related to a plurality of medical episodes, and wherein each of the plurality of medical episodes includes an associated patient, an associated physician, and an associated episode cost;
categorize each of the plurality of medical episodes in the first set of medical episode data records according to a disease stage categorization rule;
apply at least one data enhancement rule to each of the first set of medical episode data records to form an enhanced set of medical episode data records, wherein the at least one data enhancement rule is related to a parameter of the associated patient for each of the plurality of medical episodes;
identify a first medical episode data record in the enhanced set of medical episode data records, wherein the first medical episode data record includes an associated first medical episode having a first type, a first associated physician and a first associated episode cost;
identify a subset of the enhanced set of medical episode data records, wherein the subset of the enhanced set of medical episode data records includes a subset of associated medical episodes having the first type, a subset of associated physicians and a subset of associated episode costs, wherein the subset of the enhanced set of medical episode data records does not include the first medical episode data record;
apply a regression analysis to the subset of associated episode costs to identify a mean episode cost, an upper confidence level episode cost and a lower confidence level episode cost; and
compare the first associated episode cost to the upper confidence level episode cost and the lower confidence level episode cost.

13. The system of claim 12, wherein the data processing engine comprises a data pre-processing engine, and wherein the data pre-processing engine categorizes each of the plurality of medical episodes in the first set of medical episode data records according to the disease stage categorization rule.

14. The system of claim 12, wherein the data processing engine comprises a data merging, filtering and enhancement engine, and wherein the data merging, filtering and enhancement engine applies at least one data enhancement rule to each of the plurality of medical episode data records to form an enhanced set of the plurality of medical episode data records, wherein the at least one data enhancement rule is related to a parameter of the associated patient for each of the plurality of medical episodes.

15. The system of claim 12, wherein the data processing engine comprises a physician variation statistical model build engine, and wherein the physician variation statistical model build engine applies a regression analysis to the subset of associated episode costs to identify a mean episode cost, an upper confidence level episode cost and a lower confidence level episode cost.

16. The system of claim 15, wherein the physician variation statistical model build engine compares the first associated episode cost to the upper confidence level episode cost and the lower confidence level episode cost.

17. The system of claim 12, wherein applying at least one data enhancement rule to each of the plurality of medical episodes data records to form an enhanced set of the plurality of medical episode data records, wherein the at least one data enhancement rule is related to a parameter of the associated patient for each of the plurality of medical episodes, further comprises:
selecting only the medical episodes data records from the plurality of medical episode data records having a first diagnosis code.

18. A computer program product for enhancing medical data to determine variation in cost of medical services, the computer program product comprising a computer readable storage medium having program instructions embodied therewith, the program instructions executable by a data processing engine to cause the data processing engine to:
receive a first set of medical episode data records, wherein the first set of medical episode data records is related to a plurality of medical episodes, and wherein each of the plurality of medical episodes includes an associated patient, an associated physician, and an associated episode cost;
assign at least one comorbidity classification to each of the plurality of medical episodes in the plurality of medical episode data records;
apply at least one data enhancement rule to each of the first set of medical episode data records to form an enhanced set of medical episode data records, wherein the at least one data enhancement rule is related to a parameter of the associated patient for each of the plurality of medical episodes;
identify a first medical episode data record in the enhanced set of medical episode data records, wherein the first medical episode data record includes an associated first medical episode having a first type, a first associated physician and a first associated episode cost;
identify a subset of the enhanced set of medical episode data records, wherein the subset of the enhanced set of medical episode data records includes a subset of associated medical episodes having the first type, a subset of associated physicians and a subset of associated episode costs, wherein the subset of the enhanced set of medical episode data records does not include the first medical episode data record;
apply a regression analysis to the subset of associated episode costs to identify a mean episode cost, an upper confidence level episode cost and a lower confidence level episode cost; and
compare the first associated episode cost to the upper confidence level episode cost and the lower confidence level episode cost.

19. The computer program product of claim 18, wherein the program instructions executable by the data processing engine further cause the data processing engine to:
apply the comorbidity classification to the enhanced set of the plurality of medical episode data records prior to applying the regression analysis.

20. The computer program product of claim 18, wherein the program instructions executable by the data processing engine further cause the data processing engine to:
determine an efficiency level of the first associated physician based on the comparison.
